(19) United States
(12) Patent Application Publication
(10) Pub. No.: US 2025/0386156 A1
(43) Pub. Date: Dec. 18, 2025

(54) EAR WEARING SOUND OUTPUT DEVICE AND INSERTION MEMBER

(71) Applicant: Sony Group Corporation, Tokyo (JP)

(72) Inventor: Hisayoshi OTAKI, Tokyo (JP)

(73) Assignee: Sony Group Corporation, Tokyo (JP)

(21) Appl. No.: 18/832,523

(22) PCT Filed: Jan. 11, 2023
(86) PCT No.: PCT/JP2023/000495

§ 371 Date: Feb. 12, 2025

(30) Foreign Application Priority Data
Feb. 10, 2022 (JP) 2022-019866

(51) Int. Cl. H04R 25/00; H04R 1/10

(52) U.S. Cl. CPC H04R 25/654; H04R 1/1066; H04R 25/60; H04R 1/1083; H04R 25/43; H04R 2460/01; H04R 2460/17

(57) ABSTRACT

An ear wearing sound output device includes: a speaker unit; a sound guide portion that includes a hole portion having an insertion hole and transmits sound output from the speaker unit via the hole portion; and an insertion member that includes an insertion main body portion located in the insertion hole, and a tab integrally provided with the insertion main body portion and at least partially located outside the insertion hole.

### TECHNICAL FIELD

The present disclosure relates to an ear wearing sound output device and an insertion member.

### BACKGROUND ART

In an ear wearing sound output device, particularly a hearing aid worn for a long time, a foreign substance such as cerumen accumulates in a sound hole portion of an earpiece worn on an ear over time. In particular, in a hearing aid that is usually worn for a long time, a foreign substance is likely to accumulate in the sound hole portion. The foreign substance accumulated in the sound hole portion affects the characteristics of the sound emitted from the sound hole portion, and may cause adverse effects such as inability to appropriately emit sound from the hearing aid. In particular, the acoustic performance of the hearing aid is optimally adjusted according to the hearing of each user, but if a foreign substance accumulates in the sound hole portion, the finely adjusted acoustic performance is impaired.

Therefore, in some cases, a hearing aid is used in a state where a foreign substance entry prevention member, which may be called a wax guard, is inserted into the sound hole portion. The foreign substance entry prevention member is advantageous for suppressing the accumulation of a foreign substance in the sound hole portion and keeping the acoustic state of the hearing aid preferable for a long period of time.

In addition, Patent Document 1 discloses a cerumen entry prevention chip capable of suppressing deterioration of an acoustic state even when a foreign substance such as cerumen accumulates in an opening portion of a sound guiding portion of a hearing aid. That is, the cerumen entry prevention chip of Patent Document 1 includes at least two other passages connected to the sound guiding portion in addition to the opening portion of the sound guiding portion, thereby avoiding a situation in which all passages transmitting sound are blocked by the cerumen.

### CITATION LIST

### Patent Document

Patent Document 1: Japanese Patent Application Laid-Open No. 2009-200670

### SUMMARY OF THE INVENTION

### Problems to be Solved by the Invention

Even when the above-described foreign substance entry prevention member is attached to the sound hole portion of the hearing aid, a foreign substance such as cerumen gradually accumulates. Therefore, in order to maintain a preferable acoustic state for a long period of time, it is necessary to periodically replace the foreign substance entry prevention member (for example, at a frequency of about once every three months).

The opening diameter of the sound hole portion of the hearing aid is very small, and is generally about 2 to 3 mm. Accordingly, the foreign substance entry prevention member to be inserted into such a sound hole portion is also inevitably small, and it is necessary to pay attention to handling of the foreign substance entry prevention member at the time of replacement.

The replacement of the foreign substance entry prevention member can be performed by a user himself/herself. However, since the size of the foreign substance entry prevention member is very small, it is necessary to perform the replacement operation of the foreign substance entry prevention member using a dedicated tool, and the replacement of the foreign substance entry prevention member is not necessarily easy. In particular, although a large proportion of the users of the hearing aid are the elderly, replacement of a minute foreign substance entry prevention member is work involving great difficulty for the elderly. For this reason, many hearing aid users give up replacing the foreign substance entry prevention member by themselves, and bring the hearing aid to a specialized shop to have the foreign substance entry prevention member replaced at a cost.

In addition, in the future, as the price of the hearing aid decreases, persons with mild and moderate hearing loss can easily use the hearing aid as a device for assisting hearing, and it is expected that the user range of the hearing aid will expand. In addition, it is expected that the number of hearing aid users will increase in a case where not only specialized stores but also non-specialized stores handle hearing aids with the progress of revision of laws and other systems. It is desirable that the hearing aid has a configuration and a function that are advantageous for suppressing the influence of a foreign substance such as cerumen accumulated in the hole portion over a long period of time, under a situation where the number of users of the hearing aid is expected to increase as described above.

Moreover, although many earphones including microphones have recently been sold, it is also assumed that such earphones further have an external sound capturing function and are used as hearing aids. In general, the wearing time of an earphone is shorter than the wearing time of a hearing aid, but it is also assumed that an earphone having a hearing aid function is worn for a time equal to or longer than that of a hearing aid. Therefore, it is desirable that the earphone also has a configuration and a function that are advantageous for suppressing the influence of accumulation of a foreign substance such as cerumen in the hole portion over a long period of time.

The present disclosure provides a technology advantageous for suppressing the influence of a foreign substance such as cerumen accumulated in a hole portion over a long period of time in an ear wearing sound output device such as a hearing aid and an earphone.

### Solutions to Problems

One aspect of the present disclosure relates to an ear wearing sound output device including: a speaker unit; a sound guide portion that includes a hole portion having an insertion hole and transmits sound output from the speaker unit via the hole portion; and an insertion member that includes an insertion main body portion located in the insertion hole, and a tab integrally provided with the insertion main body portion and at least partially located outside the insertion hole.

The tab may include a tab coupling portion coupled to the insertion main body portion and extending in an extending direction of the insertion hole, and a tab extension portion coupled to the tab coupling portion and separated from the insertion main body portion.

The tab may have a tab coupling portion coupled to the insertion main body portion and extending in a circumferential direction of the insertion hole, and a tab extension portion coupled to the tab coupling portion and separated from the insertion main body portion.

The hole portion may have a cutout portion, and at least a part of the tab may be located in the cutout portion.

At least a part of the tab may be at a position different from the insertion main body portion with respect to the extending direction of the insertion hole. The tab may have a hollow portion covering at least a portion of the insertion hole.

The tab may have a visible marking portion.

The sound guide portion may have a visible marking portion.

At least a part of the tab may include a resin.

The rigidity of at least a part of the tab may be greater than the rigidity of the insertion main body portion.

The insertion main body portion may have a cushioning property.

The insertion member may be provided as an equalizer that adjusts the frequency of sound transmitted through the hole portion.

The insertion member may be provided as a foreign substance entry prevention body that suppresses entry of a foreign substance into the insertion hole.

The ear wearing sound output device may include a microphone.

The ear wearing sound output device may include a signal processing portion that processes a sound signal output from the microphone, and the speaker unit may output sound based on the sound signal processed by the signal processing portion.

The ear wearing sound output device may include a detachable member provided separately from the insertion member and detachably attached to the sound guide portion.

The detachable member may include an ear attachment that emits sound transmitted from the sound guide portion.

The ear wearing sound output device may have a hearing aid function of outputting surrounding sound collected by the microphone from the speaker unit.

Another aspect of the present disclosure relates to an ear wearing sound output device including: a speaker unit; a sound guide portion that includes a hole portion having an insertion hole and a cutout portion and transmits sound output from the speaker unit via the hole portion; and an insertion member including an insertion main body portion located in the insertion hole.

Another aspect of the present disclosure relates to an insertion member attached to a hole portion of an ear wearing sound output device, the insertion member including: an insertion main body portion; and a tab provided integrally with the insertion main body portion and at least partially located outside the insertion hole in a state where the insertion main body portion is located in the insertion hole of the hole portion.

### BRIEF DESCRIPTION OF DRAWINGS

FIG. 1 is an external view illustrating an example of a combination of an earphone and a charger case.

FIG. 2 is an exploded view of the earphone illustrated in FIG. 1, and illustrates an example of various devices included in the earphone.

FIG. 3 is a perspective view illustrating an example of an insertion member and a sound guide portion (particularly a hole portion) according to a first embodiment.

FIG. 4 is an enlarged perspective view of the insertion member illustrated in FIG. 3.

FIG. 5 is a perspective view illustrating an example of an insertion member and a sound guide portion (particularly a hole portion) according to a second embodiment.

FIG. 6 is an enlarged perspective view of the insertion member illustrated in FIG. 5.

FIG. 7 is a perspective view illustrating an example of an insertion member and a sound guide portion (particularly a hole portion) according to a third embodiment.

FIG. 8 is a side view of the insertion member illustrated in FIG. 7.

FIG. 9 is a perspective view illustrating an example of an insertion member and a sound guide portion (particularly a hole portion) according to a fourth embodiment.

FIG. 10 is a perspective view illustrating an example of the insertion member of the fourth embodiment.

FIG. 11 is a perspective view illustrating another example of the insertion member of the fourth embodiment.

FIG. 12 is a perspective view illustrating an example of an insertion member and a sound guide portion (particularly a hole portion) according to a fifth embodiment.

FIG. 13 is an enlarged perspective view illustrating another example of the insertion member of the fifth embodiment.

### MODE FOR CARRYING OUT THE INVENTION

The technology of the present disclosure can be widely applied to ear wearing sound output devices (hearing devices) in general used by being worn on the ear. The ear wearing sound output device can emit perceptible sound through the worn ear, and is typically configured as an earphone, a headphone, or a hearing aid.

However, the specific configuration and application of the ear wearing sound output device to which the present disclosure technology can be applied are not limited. The following embodiments will be described by taking an earphone as an example of the ear wearing sound output device, but can be appropriately applied to other ear wearing sound output devices.

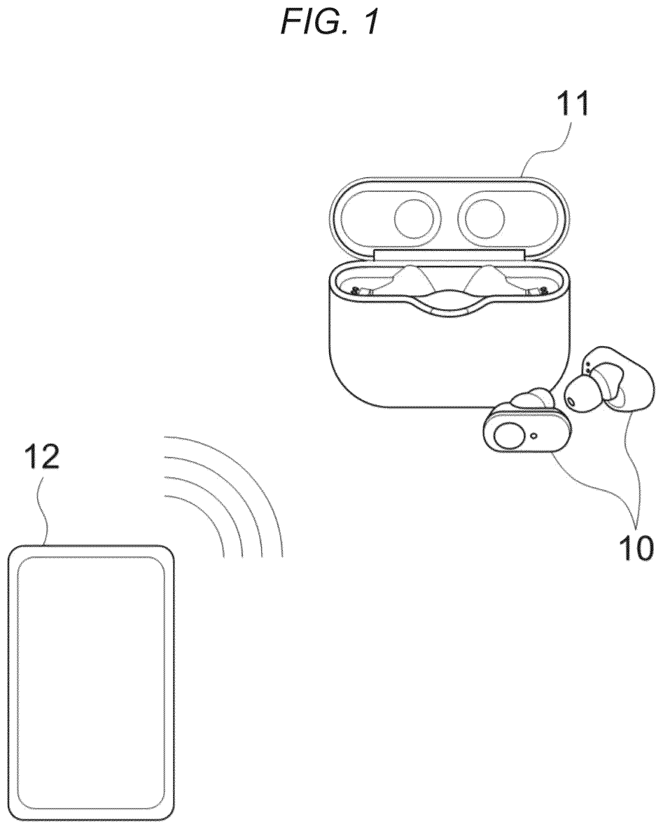

FIG. 1 is an external view illustrating an example of a combination of an earphone 10 and a charger case 11.

The earphone 10 illustrated in FIG. 1 is a completely wireless earphone without a cable, and in particular, is a True Wireless Stereo (TWS) type earphone capable of stereoscopically reproducing sound.

The earphone 10 can be housed in the dedicated charger case 11 on which a battery is mounted, and are charged while housed in the charger case 11. Note that the charger case 11 may include further equipment (not illustrated) such as a control circuit in addition to the battery. The control circuit mounted on the charger case 11 may transmit and receive data to and from a control circuit of the earphone 10 and/or an electronic apparatus 12, and may control other equipment (including the battery) mounted on the charger case 11.

A user can listen to the sound emitted from the earphone 10 by taking out the earphone 10 from the charger case 11 and putting the earphone 10 on his/her ear.

The earphone 10 may perform various functions in conjunction with removal from the charger case 11 and housing in the charger case 11. For example, the earphone 10 may be removed from the charger case 11 to automatically power the earphone 10 on or automatically establish a wireless connection between the electronic apparatus 12, such as a smartphone, and the earphone 10. As similar to this, the earphone 10 may be housed in the charger case 11 to automatically power off the earphone or automatically disconnect the wireless connection between the electronic apparatus 12 and the earphone 10. When the earphone 10 is taken out from the charger case 11 or stored in the charger case 11, time information May be acquired in the control circuit of the earphone 10, the charger case 11, and/or the electronic apparatus 12. The control circuit of the earphone 10, the charger case 11, and/or the electronic apparatus 12 may obtain additional information on the basis of the time information thus obtained, such as a calculation of a user's wear time of the earphone 10.

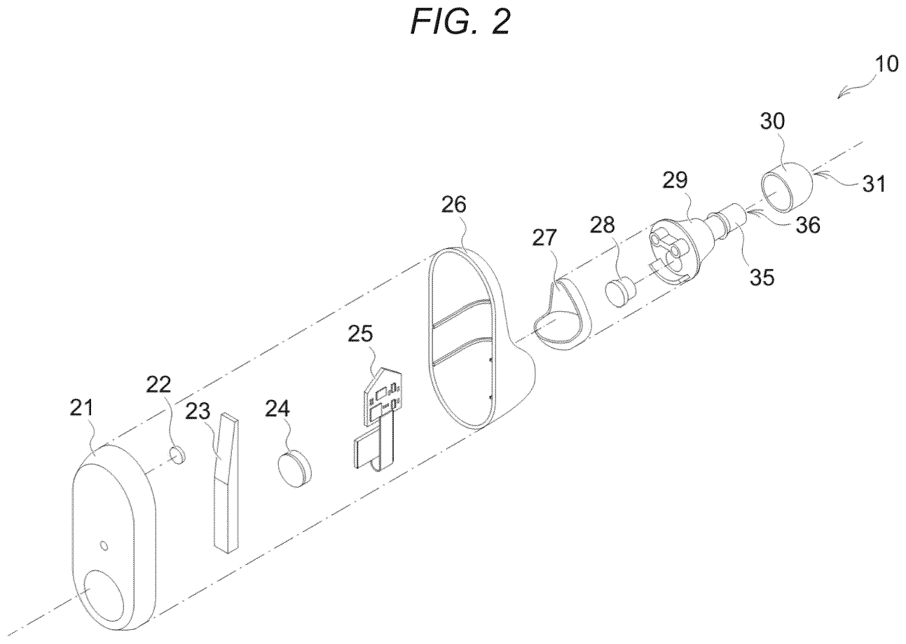

FIG. 2 is an exploded view of the earphone 10 illustrated in FIG. 1, and illustrates an example of various devices included in the earphone 10.

FIG. 2 illustrates only one of a pair of earphone parts included in the earphone 10 (for example, an earphone part for right ear attachment). The other earphone part (for example, an earphone part for left ear attachment) may be configured similarly to the earphone part illustrated in FIG. 2, or may have a configuration different from the earphone part illustrated in FIG. 2. Note that the earphone 10 to which the earphone part example illustrated in FIG. 2 can be applied is not limited to the earphone for both ears as illustrated in FIG. 1, and the above-described technology can also be applied to the earphone for one ear.

An earphone part of the earphone 10 illustrated in FIG. 2 includes a top case 21, a microphone 22, an antenna 23, an earphone battery 24, a control circuit 25, a bottom case 26, a supporter 27, a speaker unit 28, a sound guide portion 29, and an earpiece 30.

The top case 21 and the bottom case 26 are fixedly attached to each other, and create a first housing space surrounded by the top case 21 and the bottom case 26. A microphone 22, an antenna 23, an earphone battery 24, and a control circuit 25 are fixedly positioned in the first housing space.

The microphone 22 is positioned between the top case 21 and the antenna 23, and is configured as a sound collector that detects sound around the earphone 10. The surrounding sound that can be collected by the microphone 22 includes sound in general emitted in the surrounding environment, and also includes the voice of a person interacting with the user wearing the earphone 10. The microphone 22 outputs a sound signal of the detected surrounding sound to the control circuit 25.

The antenna 23 transmits and receives signals to and from an external apparatus. For example, signals may be transmitted and received between the electronic apparatus 12 (see FIG. 1) or the other earphone part (for example, an earphone part for left ear attachment) and the antenna 23.

The earphone battery 24 is a power source for various devices included in the earphone 10, and supplies power to various devices as necessary. The earphone battery 24 is charged with power supplied from a battery (not illustrated) of the charger case 11 while the earphone 10 is housed in the charger case 11.

The control circuit 25 controls various devices included in the earphone 10. The control circuit 25 is electrically connected to the earphone battery 24, and is driven by using power supplied from the earphone battery 24.

The specific content of the control performed by the control circuit 25 is not limited.

Typically, the control circuit 25 provides an electrical sound signal to the speaker unit 28, processes a signal received via the antenna 23, and transmits a signal via the antenna 23.

As an example, the control circuit 25 can perform signal processing on a sound signal (for example, a sound signal and/or a music signal) from the electronic apparatus 12 (see FIG. 1) received via the antenna 23, and transmit the sound signal after the signal processing to the speaker unit 28.

The control circuit 25 illustrated in FIG. 2 also serves as a signal processing portion that processes a sound signal output from the microphone 22. For example, the sound signal output from the microphone 22 may be subjected to any signal processing in the control circuit 25 and then transmitted from the control circuit 25 to the speaker unit 28.

In addition, the control circuit 25 may generate a noise-cancelling signal that reduces ambient sound on the basis of a sound signal output from the microphone 22. The control circuit 25 may transmit only the noise-cancelling signal to the speaker unit 28, or may apply (for example, superimpose) the noise-cancelling signal to another sound signal to be transmitted to the speaker unit 28.

The supporter 27 is fixedly attached to the bottom case 26.

The sound guide portion 29 is fixedly attached to the supporter 27, and a second housing space surrounded by the supporter 27 and the sound guide portion 29 is created. The speaker unit 28 is fixedly positioned in the second housing space.

The speaker unit 28 is a device that converts electrical vibration into physical vibration, and outputs sound corresponding to a sound signal transmitted from the control circuit 25.

The speaker unit 28 illustrated in FIG. 2 is electrically connected to the microphone 22 via the control circuit 25, and can reflect the surrounding sound captured by the microphone 22 on the basis of the external sound capturing function in the sound emitted from the speaker unit 28.

As an example, the speaker unit 28 can emit the surrounding sound itself collected by the microphone 22. In this case, the earphone 10 can exhibit a hearing aid function, and the user can listen to surrounding sound through the earphone 10. The earphone 10 can have a hearing aid function of outputting surrounding sound collected by the microphone 22 from the speaker unit 28.

In a case where the earphone 10 has a hearing aid function, the control circuit 25 may perform any signal processing for improving hearing ease on the sound signal from the microphone 22 and transmit the sound signal after the signal processing to the speaker unit 28. The specific processing content of the “signal processing for improving hearing ease” mentioned here is not limited. Typically, the control circuit 25 can perform signal amplification processing based on acoustic elements such as sound sensitivity, dynamic range, frequency resolution, time resolution, and directionality, and/or signal processing for improving the SN ratio by cutting noise. The content and extent of signal processing performed in the control circuit 25 may be changeable, for example, by the manufacturer, seller, and/or user of the earphone 10, and the control circuit 25 is capable of performing signal processing that is optimized for hearing of individual users, for example. As described above, the earphone 10 adjusts the characteristics (for example, the sound pressure and the like) of the surrounding sound taken in by the microphone 22 according to the user's hearing, and outputs the sound after the adjustment from the speaker unit 28, thereby exerting the hearing aid function.

The sound guide portion 29 includes a hole portion 35 and transmits the sound output from the speaker unit 28 via the hole portion 35. The hole portion 35 includes an insertion hole 36 extending in the extending direction. One end portion of the insertion hole 36 is directed to the speaker unit 28, and the other end portion is directed to the earpiece 30. An insertion member (that is, an equalizer) to be described later is disposed in the insertion hole 36 (for example, an end portion on the earpiece 30 side).

The earpiece 30 is attached to the sound guide portion 29. The earpiece 30 is a part that directly comes into contact with the user's ear when the user wears the earphone 10, and serves as an ear attachment that emits the sound transmitted by the sound guide portion 29.

The earpiece 30 is configured as a detachable member detachably attached to the sound guide portion 29, and is provided separately from the insertion member 40.

The earpiece 30 has an output through hole 31, and the sound transmitted from the sound guide portion 29 is emitted through the output through hole 31. The output through hole 31 is connected to the sound guide portion 29 (particularly, the insertion hole 36 of the hole portion 35), and the output through hole 31 and the insertion hole 36 form a sound hole portion that transmits the sound emitted by the speaker unit 28.

In the example illustrated in FIG. 2, the earpiece 30 is attached to the sound guide portion 29 by inserting the hole portion 35 of the sound guide portion 29 into the output through hole 31 of the earpiece 30. Therefore, in a state where the earpiece 30 is attached to the sound guide portion 29, the tip end portion of the hole portion 35 of the sound guide portion 29 (that is, the opening portion of the insertion hole 36) is located in the output through hole 31.

Note that the output through hole 31 of the earpiece 30 is not necessarily directly connected to the insertion hole 36 of the hole portion 35, and a space (interval) may be provided between the output through hole 31 and the insertion hole 36. From the viewpoint of sound transmission, it is preferable that no other member is provided between the output through hole 31 and the insertion hole 36, but another member may be provided between the output through hole 31 and the insertion hole 36.

In the earphone 10 having the above-described configuration, an insertion member is detachably disposed in the insertion hole 36 of the sound guide portion 29.

The insertion member is provided as an equalizer (acoustic resistance member) that adjusts the frequency of the sound transmitted via the hole portion 35, and can adjust, for example, the balance of the medium to high pitches.

As described above, the output through hole 31 of the earpiece 30 is connected to the insertion hole 36 of the sound guide portion 29. Therefore, a foreign substance such as cerumen of the user wearing the earphone 10 gradually enters the insertion hole 36 through the output through hole 31, and contaminates the insertion member located in the insertion hole 36.

When the insertion member is contaminated with cerumen or the like, it becomes difficult to exhibit the original frequency adjustment function. In particular, if the insertion member is excessively contaminated by cerumen or the like, sound cannot be appropriately transmitted from the hole portion 35 to the earpiece 30, and sound of a sufficient size may not be emitted from the earpiece 30 to the user.

Therefore, the insertion member of the present embodiment is provided as a replaceable member, and the user can periodically replace the insertion member and attach a new insertion member to the sound guide portion 29.

In particular, according to the earphone 10 described below as an example, since each user can easily perform the replacement work of the insertion member, it is possible to suppress the influence of a foreign substance such as cerumen accumulated in the hole portion for a long period of time.

Hereinafter, specific embodiments of the earphone (in particular, the sound guide portion 29 and the insertion member) will be described.

### First Embodiment

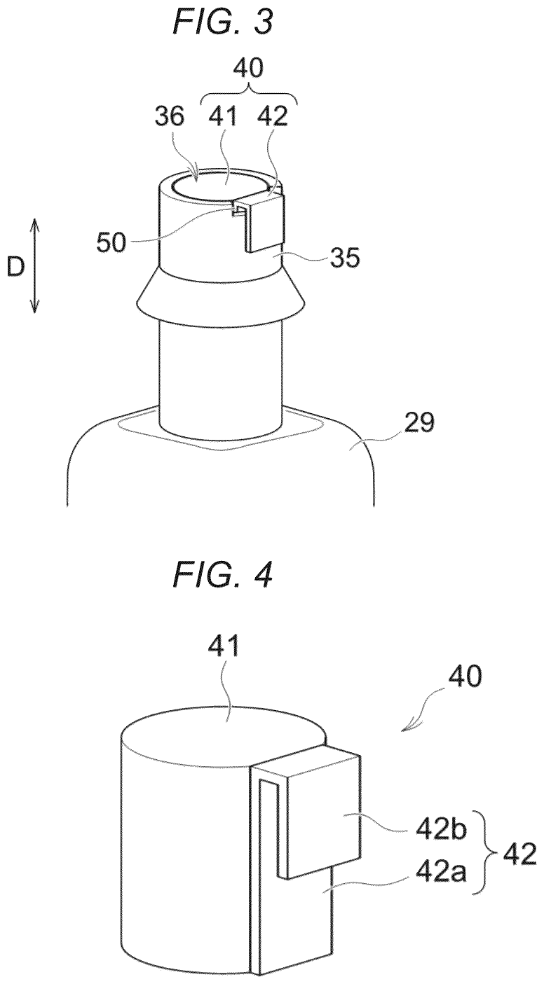

FIG. 3 is a perspective view illustrating an example of an insertion member 40 and a sound guide portion 29 (particularly a hole portion 35) according to a first embodiment. FIG. 4 is an enlarged perspective view of the insertion member 40 illustrated in FIG. 3.

The insertion member 40 includes an insertion main body portion 41 and a tab 42.

In a state where the insertion member 40 is attached to the hole portion 35 of the sound guide portion 29, the insertion main body portion 41 is located in the insertion hole 36 inside the hole portion 35, and at least a part of the tab 42 is located outside the insertion hole 36.

The insertion main body portion 41 is a portion that exhibits an original function of the insertion member 40 (a function as an equalizer in the present embodiment). The tab 42 is a portion that improves the handleability of the insertion member 40, and is intended to be held by the user when the insertion member 40 is attached to and detached from the sound guide portion 29.

The insertion main body portion 41 of the present example is configured by a member having cushioning properties (for example, urethane foam), and exhibits excellent elasticity, flexibility, and recoverability.

The insertion main body portion 41 has a shape corresponding to the shape of the insertion hole 36 (that is, the shape of the inner wall surface of the hole portion 35 defining the insertion hole 36), and is in close contact with the inner wall surface of the hole portion 35 without a gap by being inserted into the insertion hole 36. The insertion main body portion 41 illustrated in FIGS. 3 and 4 has a cylindrical shape, and has a cross-sectional diameter equal to or slightly larger than the cross-sectional diameter of the cylindrical insertion hole 36. As an example, the insertion main body portion 41 can have a cross-sectional diameter on the order of 4 to 5 mm.

Since the insertion main body portion 41 (insertion member 40) is provided so as to close the insertion hole 36 as described above, the insertion main body portion 41 not only exhibits a frequency adjustment function as an equalizer, but also acts as a foreign substance entry prevention member that suppresses entry and accumulation of a foreign substance into the insertion hole 36.

The tab 42 has a film shape, and at least a part thereof is configured by a flexible member. At least a part of the tab 42 can be configured by a general-purpose material (for example, polyethylene terephthalate (PET)) such as a resin. The PET is excellent in processability, can be easily processed into a desired film shape, can be colored, and can be easily disposed when unnecessary.

The tab 42 illustrated in FIGS. 3 and 4 includes a tab coupling portion 42a and a tab extension portion 42b provided adjacent to each other, and has a band shape having a constant size in a width direction perpendicular to the longitudinal direction as a whole.

The tab coupling portion 42a is coupled to the side circumferential surface of the insertion main body portion 41 and extends along the extending direction of the insertion main body portion 41. Accordingly, the longitudinal direction of the tab coupling portion 42a (tab 42) corresponds to the extending direction of the insertion main body portion 41, and the width direction of the tab coupling portion 42a (tab 42) corresponds to the circumferential direction of the insertion main body portion 41.

Note that, in a state where the insertion member 40 is attached to the sound guide portion 29, the extending direction of the insertion main body portion 41 corresponds to the extending direction of the insertion hole 36 (see reference numeral “D” in FIG. 3), and the circumferential direction of the insertion main body portion 41 corresponds to the circumferential direction of the insertion hole 36.

The tab extension portion 42b couples to the tab coupling portion 42a and is separate from the insertion main body portion 41.

The term “coupling” as used herein may refer not only to a case where separate members are fixed to each other, but also to a case where a plurality of portions is configured by an integrated single member. Therefore, the insertion main body portion 41 and the tab 42 may be configured by separate members from each other, or may be formed as an integral structure having no joint surface by a single member. In addition, the tab coupling portion 42a and the tab extension portion 42b are typically formed as an integral structure having no joint surface, but may be configured by separate members.

In the example illustrated in FIGS. 3 and 4, the tab coupling portion 42a of the tab 42 is attached to the insertion main body portion 41 having a cushioning property by an adhesive or thermal bonding. The rigidity of at least a part of the tab 42 (particularly the tab coupling portion 42a that couples to the insertion main body portion 41) is higher than the rigidity of the insertion main body portion 41. The tab 42 (in particular the tab coupling portion 42a) thus serves to increase the rigidity of the insertion main body portion 41.

On the other hand, the hole portion 35 of the sound guide portion 29 has a cutout portion 50 formed as a space connected to the insertion hole 36, and at least a part of the tab 42 is located in the cutout portion 50. In the example illustrated in FIG. 3, the cutout portion 50 slightly wider than the tab 42 is formed at a distal end portion of the hole portion 35 forming the opening portion of the insertion hole 36. However, the specific position, shape, and size of the cutout portion 50 are not limited.

The insertion member 40 is attached to the hole portion 35 with the tab 42 (in particular, the tab extension portion 42b) folded back, and a folded portion of the tab 42 (that is, a portion of the tab extension portion 42b) is positioned in the cutout portion 50. As a result, while the tab coupling portion 42a is positioned in the insertion hole 36 inside the hole portion 35, at least a part of the tab extension portion 42b is positioned outside the hole portion 35.

Therefore, the tab 42 extends along the inner wall surface and the outer wall surface of the hole portion 35 inside and outside the hole portion 35, and is basically provided so as not to protrude from the hole portion 35 in the extending direction of the insertion main body portion 41 (that is, the extending direction D of the insertion hole 36).

By coupling the tab 42 to the side wall (side circumferential surface) of the insertion main body portion 41 in this manner, it is possible to suppress an increase in length of the tab 42 in the extending direction of the insertion main body portion 41. By coupling the tab 42 to the side wall (side circumferential surface) of the insertion main body portion 41, it is possible to suppress the influence of the tab 42 on the sound transmitted through the insertion hole 36, and the insertion member 40 (particularly, the insertion main body portion 41) can appropriately exhibit its original acoustic function.

In a state where the insertion member 40 is attached to the sound guide portion 29, the tab extension portion 42b (particularly, a portion extending along the outer wall surface of the hole portion 35) is sandwiched and fixedly supported by the hole portion 35 and the earpiece 30 (see FIG. 2). As a result, the relative position of the insertion member 40 with respect to the hole portion 35 is fixed, and the insertion member 40 can be prevented from unintentionally protruding or falling off from the sound guide portion 29.

According to the sound guide portion 29 and the insertion member 40 having the above-described configurations, the insertion member 40 can be easily attached to and detached from the hole portion 35 of the sound guide portion 29, and the replacement work of the insertion member 40 can be easily and accurately performed in a short time.

That is, the user can attach and detach the insertion member 40 to and from the sound guide portion 29 by moving the insertion member 40 while holding the tab extension portion 42b. The tab extension portion 42b is located outside the hole portion 35 and exposed even in a state where the insertion member 40 is attached to the sound guide portion 29. Therefore, by holding such tab extension portion 42b and moving the insertion member 40, the user can insert the insertion member 40 (in particular, the insertion main body portion 41) into the insertion hole 36 and appropriately arrange the insertion member 40 at a desired position without being disturbed by the hole portion 35.

Accordingly, even an elderly person or a beginner who is not accustomed to the replacement work of the insertion member 40 can easily replace the insertion member 40 by himself/herself without intervention of an expert.

By thus simplifying the replacement work of the insertion member 40, each user can easily replace the insertion member 40 as necessary, and each user is urged to timely replace the insertion member 40. As a result, the influence of a foreign substance such as cerumen accumulated in hole portion 35 can be suppressed over a long period of time, and temporal deterioration of sound quality of sound output from the earphone 10 can be suppressed.

In addition, the insertion member 40 of the present embodiment includes not only the insertion main body portion 41 located inside the hole portion 35 but also the tab 42 (particularly, the tab extension portion 42b) located outside the hole portion 35. Accordingly, the insertion member 40 is configured as a component larger than the insertion main body portion 41 as a whole. Therefore, handleability of the insertion member 40 is improved, and workability of replacement of the insertion member 40 is expected to be improved.

In the present embodiment, in a state where the insertion member 40 is located in the insertion hole 36, the extending direction of the insertion main body portion 41 and the extending direction D of the insertion hole 36 coincide with each other, and in particular, the longitudinal direction of the tab 42 and the extending direction D of the insertion hole 36 coincide with each other. Therefore, the user can intuitively insert and remove the insertion member 40 into and from the hole portion 35 while holding the tab extension portion 42b.

In addition, in a state where the insertion member 40 is attached to the sound guide portion 29, a part of the insertion member 40 (particularly, the tab extension portion 42b of the tab 42) is located outside the hole portion 35. Therefore, the user can easily visually recognize the position of the tab extension portion 42b, and can analogically grasp the position of the entire insertion member 40 with respect to the sound guide portion 29 on the basis of the position of the tab extension portion 42b.

As described above, the tab 42 (in particular, the tab extension portion 42b) is useful as a mark for positioning the insertion member 40 with respect to the hole portion 35, and is useful for accurately arranging the insertion member 40 at a desired position of the insertion hole 36.

Moreover, in the present embodiment, since the cutout portion 50 of the hole portion 35 can be used as a mark indicating the target position regarding the arrangement of the tab 42, the arrangement accuracy of the insertion member 40 with respect to the hole portion 35 is further improved.

Note that, from the viewpoint of improving workability of replacement of the insertion member 40, it is preferable that the insertion member 40 has a color different from that of the sound guide portion 29 (particularly, the hole portion 35). In particular, it is preferable that the tab extension portion 42b directly gripped by the user has a color different from not only the sound guide portion 29 (in particular, the hole portion 35) but also the insertion main body portion 41 and the tab coupling portion 42a from the viewpoint of improving visibility.

From the viewpoint of making the insertion member 40 (particularly, the tab 42 (for example, the tab extension portion 42b)) have a color excellent in visibility as described above, it is preferable that the insertion member 40 is configured by a member that can be colored (for example, PET).

In addition, a covering member that covers the insertion hole 36 and is not detachable is not attached to the hole portion 35 of the sound guide portion 29 of the present embodiment, and the insertion member 40 is attached to the hole portion 35 in a state of being exposed through the opening portion of the insertion hole 36. In addition, the earpiece 30 is detachably provided with respect to the sound guide portion 29, and the insertion member 40 attached to the hole portion 35 can be exposed by detaching the earpiece 30 from the sound guide portion 29.

Therefore, the user can easily replace only the insertion member 40 by detaching the earpiece 30 from the sound guide portion 29.

On the other hand, in the conventional earphone, basically, replacement of the equalizer by an individual user is not assumed. In addition, a cerumen prevention mechanism (foreign substance entry prevention body) is often provided so as to be covered with a component (for example, mesh) that cannot be detached. As described above, the conventional earphone often has a structure in which an insertion member such as an equalizer or a cerumen prevention mechanism cannot be basically taken out from the sound hole portion. In order to replace the insertion member in such a conventional earphone, it is necessary to also detach peripheral components that are not estimated to be replaced, so that the replacement work is difficult and the replacement cost of the insertion member is high.

On the other hand, according to the earphone 10 of the present embodiment in which only the insertion member 40 (equalizer) can be easily replaced, the insertion member 40 can be replaced inexpensively in a short time.

In addition, since the tab 42 (particularly, the tab coupling portion 42a) having high rigidity is attached to the insertion main body portion 41 having a cushioning property, rigidity of the insertion member 40 as a whole is enhanced while having a cushioning property. This improves the handleability of the insertion member 40. In particular, since the tab 42 directly gripped by the user has high rigidity, the user can easily grip the tab 42, which is advantageous in terms of work efficiency of replacement of the insertion member 40.

### Second Embodiment

In the present embodiment, elements same as or corresponding to those in the first embodiment described above are denoted by the same reference numerals, and the detailed description thereof will be omitted.

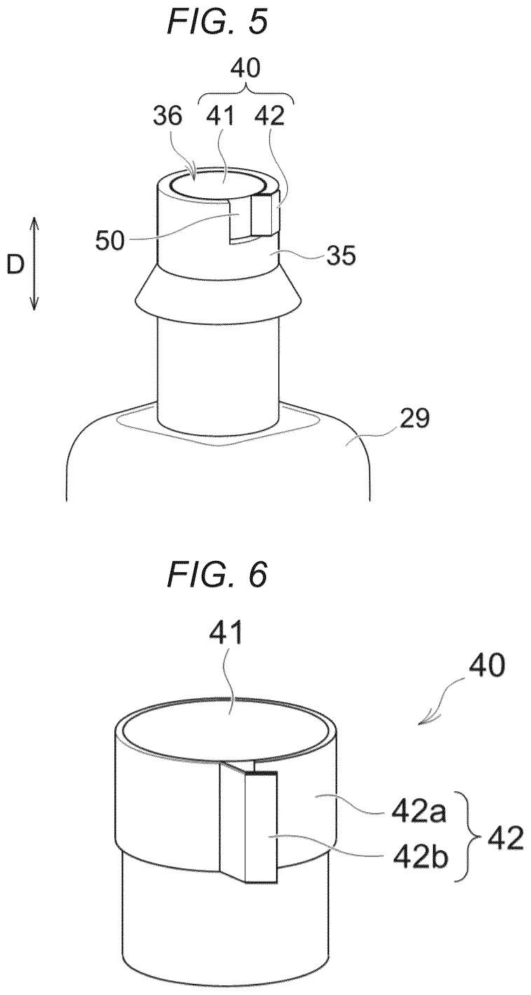

FIG. 5 is a perspective view illustrating an example of the insertion member 40 and the sound guide portion 29 (in particular, the hole portion 35) according to a second embodiment. FIG. 6 is an enlarged perspective view of the insertion member 40 illustrated in FIG. 5.

In the present embodiment, the tab 42 of the insertion member 40 extends along the circumferential direction of the insertion main body portion 41.

That is, the tab coupling portion 42a coupled to the insertion main body portion 41 extends in the circumferential direction of the insertion main body portion 41 along the outer peripheral wall surface of the insertion main body portion 41. In addition, the tab extension portion 42b, which is coupled to the tab coupling portion 42a and separate from the insertion main body portion 41, extends in the circumferential direction of the insertion main body portion 41 essentially without being folded back.

The tab 42 of the present embodiment also has a tab coupling portion 42a and a tab extension portion 42b provided adjacent to each other, and has a band-like shape having a constant width as a whole. However, the longitudinal direction of the tab 42 corresponds to the circumferential direction of the insertion main body portion 41, and the width direction of the tab 42 corresponds to the extending direction of the insertion main body portion 41.

In a state where the insertion member 40 is attached to the sound guide portion 29, the insertion main body portion 41 and the tab coupling portion 42a are located in the insertion hole 36 inside the hole portion 35, and in particular, the tab coupling portion 42a extends in the circumferential direction of the insertion hole 36. On the other hand, the tab extension portion 42b extends so as to penetrate the cutout portion 50 of the hole portion 35, and a part of the tab extension portion 42b is located outside the hole portion 35.

As described above, in the present embodiment, the longitudinal direction of the tab 42 corresponds to the circumferential direction of the insertion hole 36. Therefore, the width of the cutout portion 50 (that is, the length of the cutout portion 50 in the direction perpendicular to the extending direction D of the insertion hole 36) may be smaller than the width of the tab 42 (in particular, the tab extension portion 42b).

That is, the width of the cutout portion 50 may be equal to or larger than the thickness of the tab extension portion 42b so that the tab extension portion 42b can penetrate the cutout portion 50. More preferably, the width of the cutout portion 50 is larger than the thickness of the tab extension portion 42b and smaller than the longitudinal size of the tab extension portion 42b.

On the other hand, from the viewpoint of avoiding the tab 42 from protruding from the hole portion 35 in a state where the insertion member 40 is attached to the sound guide portion 29, it is preferable that the length of the cutout portion 50 in the extending direction (that is, the length of the cutout portion 50 in the extending direction D of the insertion hole 36) is equal to or larger than the width of the tab extension portion 42b. More preferably, the length of the cutout portion 50 in the extending direction is larger than the width of the tab extension portion 42b.

According to the sound guide portion 29 and the insertion member 40 having the above-described configurations, the insertion member 40 can be easily attached to and detached from the hole portion 35 of the sound guide portion 29, and the replacement work of the insertion member 40 can be easily and accurately performed in a short time.

In particular, according to the present embodiment, the longitudinal direction of the tab 42 corresponds to the circumferential direction of the insertion hole 36 and the insertion main body portion 41. Therefore, it is possible to more reliably prevent the insertion member 40 from protruding from the hole portion 35 in the extending direction D of the insertion hole 36.

The tab extension portion 42b can extend along the outer peripheral surface of the distal end portion of the hole portion 35 without having a folded structure. Therefore, the insertion member 40 and the sound guide portion 29 of the present embodiment are advantageous for attaching the insertion member 40 to the sound guide portion 29 while suppressing the degree of protrusion of the insertion member 40 (in particular, the tab 42) from the hole portion 35.

### Third Embodiment

In the present embodiment, elements same as or corresponding to those in the first and second embodiments described above are denoted by the same reference numerals, and the detailed description thereof will be omitted.

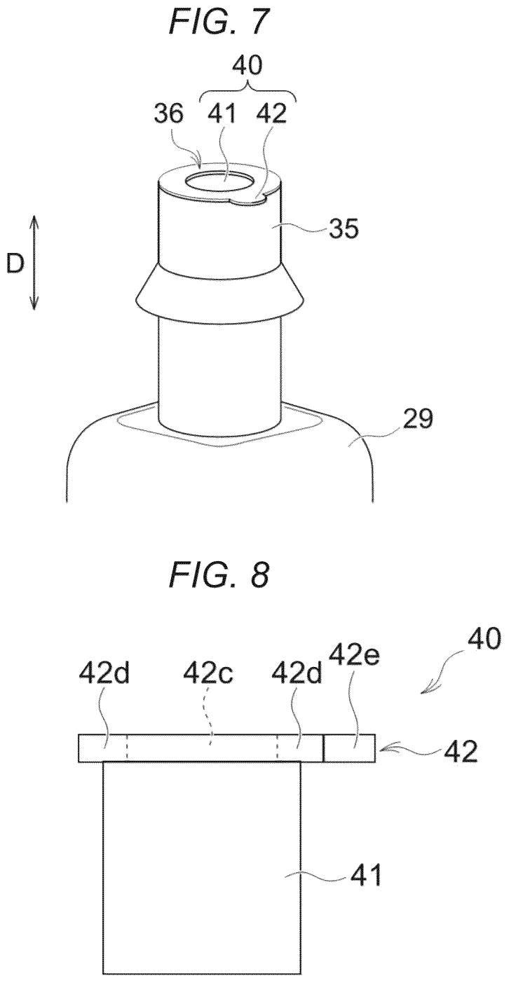

FIG. 7 is a perspective view illustrating an example of the insertion member 40 and the sound guide portion 29 (in particular, the hole portion 35) according to a third embodiment. FIG. 8 is a side view of the insertion member 40 illustrated in FIG. 7.

At least a part of the tab 42 of the present embodiment is at a position different from the insertion main body portion 41 with respect to the extending direction of the insertion main body portion 41. That is, in a state where the insertion member 40 is attached to the sound guide portion 29, at least a part of the tab 42 is at a position different from the insertion main body portion 41 in the extending direction D of the insertion hole 36.

In the example illustrated in FIGS. 7 and 8, in a state where the insertion member 40 is attached to the sound guide portion 29, the entire insertion main body portion 41 is positioned in the insertion hole 36 inside the hole portion 35, and the entire tab 42 is positioned outside the hole portion 35.

The tab 42 has an outer peripheral surrounding portion 42d surrounding a hollow portion 42c and an outer peripheral extension portion 42e extending outward from the outer peripheral surrounding portion 42d. In the example illustrated in FIGS. 7 and 8, the outer peripheral surrounding portion 42d has an annular planar shape, and the hollow portion 42c has a circular planar shape.

The hollow portion 42c is a space defined by the outer peripheral surrounding portion 42d. In a state where the insertion member 40 is attached to the sound guide portion 29, the hollow portion 42c covers at least a part of the insertion hole 36.

The outer peripheral surrounding portion 42d extends so as to cover the distal end surface of the wall portion of the hole portion 35 outside the hole portion 35. In a state where the insertion member 40 is attached to the sound guide portion 29, the outer peripheral surrounding portion 42d serves as a stopper that suppresses excessive entry of the insertion member 40 into the insertion hole 36.

The outer peripheral surrounding portion 42d illustrated in FIGS. 7 and 8 extends so as to protrude from the wall portion of the hole portion 35 in a direction perpendicular to the extending direction D of the insertion hole 36. However, the outer peripheral surrounding portion 42d does not need to protrude from the wall portion of the hole portion 35 in a direction perpendicular to the extending direction D of the insertion hole 36.

The entire outer peripheral extension portion 42e is located outside the hole portion 35 (sound guide portion 29). In particular, the outer peripheral extension portion 42e illustrated in FIGS. 7 and 8 is provided so as not to overlap the insertion main body portion 41 in the extending direction of the insertion main body portion 41.

The hole portion 35 illustrated in FIG. 7 does not have the cutout portion 50 (see FIGS. 3 and 5), and hole portion 35 is configured by a hollow cylindrical member. However, the hole portion 35 may have the cutout portion 50. For example, the cutout portion 50 may be formed at the distal end portion of the hole portion 35 forming the opening portion of the insertion hole 36, and at least a part of the outer peripheral surrounding portion 42d and/or at least a part of the outer peripheral extension portion 42e may be arranged in the cutout portion 50.

According to the sound guide portion 29 and the insertion member 40 having the above-described configurations, the insertion member 40 is configured as a lid body for the hole portion 35. Therefore, the user can attach the insertion member 40 to the sound guide portion 29 by pushing the insertion main body portion 41 of the insertion member 40 into the insertion hole 36 of the hole portion 35 so as to cover the hole portion 35 with the insertion member 40. In addition, the user can detach the insertion member 40 from the sound guide portion 29 by pulling up the insertion member 40 from the hole portion 35 while holding the outer peripheral extension portion 42e.

As described above, according to the sound guide portion 29 and the insertion member 40 of the present embodiment, it is possible to intuitively attach and detach the insertion member 40 to and from the sound guide portion 29.

In addition, since the hollow portion 42c is provided so as to cover the insertion hole 36 and the insertion main body portion 41, it is possible to suppress the acoustic influence of the tab 42 on the sound transmitted from the speaker unit 28 (see FIG. 2) via the sound guide portion 29 (including the insertion hole 36).

### Fourth Embodiment

In the present embodiment, elements same as or corresponding to those in the first to third embodiments described above are denoted by the same reference numerals, and the detailed description thereof will be omitted.

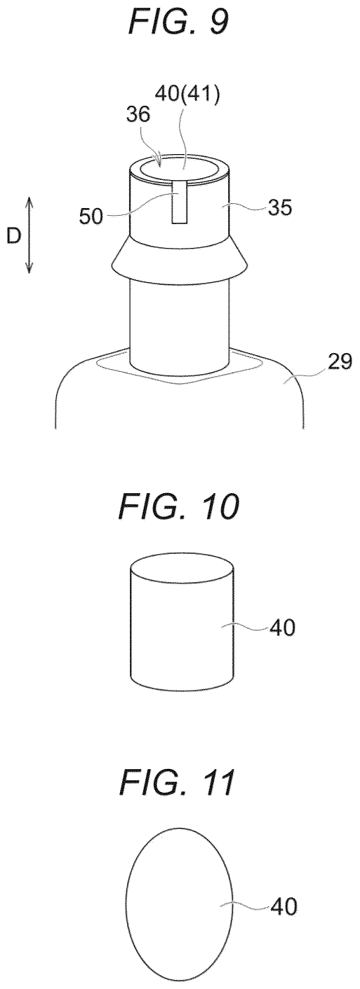

FIG. 9 is a perspective view illustrating an example of the insertion member 40 and the sound guide portion 29 (particularly the hole portion 35) according to a fourth embodiment. FIG. 10 is a perspective view illustrating an example of the insertion member 40 of the fourth embodiment. FIG. 11 is a perspective view illustrating another example of the insertion member 40 of the fourth embodiment.

In the present embodiment, the hole portion 35 of the sound guide portion 29 has the cutout portion 50. In the example illustrated in FIG. 9, the cutout portion 50 is formed at a distal end portion of the hole portion 35 forming the opening portion of the insertion hole 36.

The insertion member 40 is located so as to close the distal end opening of the hole portion 35 in the insertion hole 36, and is partially exposed to the outside of the hole portion 35 through the cutout portion 50.

The insertion member 40 illustrated in FIG. 9 does not have the above-described tab 42, has only the insertion main body portion 41 positioned in the insertion hole 36 inside the hole portion 35, and does not protrude to the outside of the hole portion 35. However, the cushioning insertion member 40 may bulge into the cutout portion 50 while being located in the insertion hole 36, or may be entirely positioned in the insertion hole 36 without bulging into the cutout portion 50.

The insertion member 40 not attached to the sound guide portion 29 has a maximum cross-sectional diameter larger than the minimum cross-sectional diameter of the insertion hole 36 in a direction perpendicular to the extending direction. When the insertion member 40 is attached to the sound guide portion 29, the cushioning insertion member 40 is inserted into the insertion hole 36 in a compressed state. The insertion member 40 positioned in the insertion hole 36 is in close contact with the inner wall surface of the hole portion 35, and the position in the insertion hole 36 is fixed by frictional force received from the inner wall surface of the hole portion 35.

Since the insertion member 40 of the present embodiment does not have the tab 42, the insertion member 40 can adopt a simple shape.

Typically, the insertion member 40 may have a cylindrical shape (see FIG. 10) corresponding to the shape of the insertion hole 36, or may have a symmetrical shape such as an egg shape (see FIG. 11) or a spheroid shape. The insertion member 40 (see FIG. 10) having a columnar shape corresponding to the shape of the insertion hole 36 can secure a large contact area with respect to the inner wall surface of the hole portion 35, and is thus excellent in position fixability in the insertion hole 36. On the other hand, since the insertion member 40 (see FIG. 11) having the outer peripheral surface including a smooth curved surface can be smoothly moved in the insertion hole 36, it is excellent in detachability with respect to the hole portion 35.

However, the shape of the insertion member 40 is not limited, and for example, the insertion member 40 may have an asymmetric shape.

According to the sound guide portion 29 and the insertion member 40 having the above-described configurations, the user can easily attach and detach the insertion member 40 to and from the sound guide portion 29 using the cutout portion 50.

For example, the user can easily attach and detach the insertion member 40 to and from the sound guide portion 29 by moving the insertion member 40 using an elongated member (not illustrated) such as a pin that can pass through the cutout portion 50. In addition, in a case where the cutout portion 50 has a size that allows the user's nail to enter, the user can easily attach and detach the insertion member 40 to and from the sound guide portion 29 using the nail without using a tool.

### Fifth Embodiment

In the present embodiment, elements same as or corresponding to those in the first to fourth embodiments described above are denoted by the same reference numerals, and the detailed description thereof will be omitted.

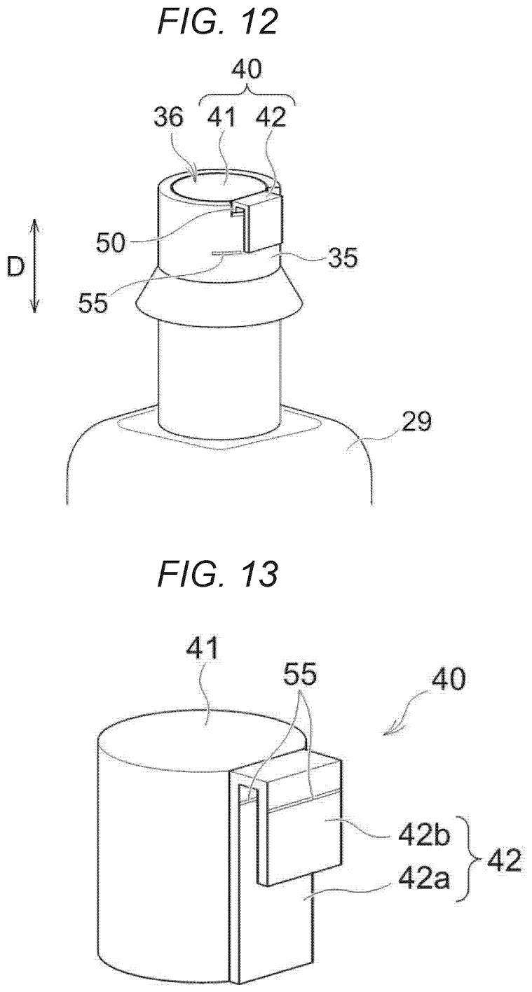

FIG. 12 is a perspective view illustrating an example of the insertion member 40 and the sound guide portion 29 (particularly, the hole portion 35) according to a fifth embodiment. FIG. 13 is an enlarged perspective view illustrating another example of the insertion member 40 of the fifth embodiment.

The sound guide portion 29 and/or the insertion member 40 of the present embodiment includes a marking portion 55 visually recognizable by the user.

In the example illustrated in FIG. 12, the marking portion 55 is provided on the outer wall of the hole portion 35 of the sound guide portion 29. In the example illustrated in FIG. 13, the marking portion 55 is provided on each of the tab coupling portion 42a and the tab extension portion 42b of the tab 42.

When the user attaches and detaches the insertion member 40 to and from the sound guide portion 29, the user can use the marking portion 55 as an index.

For example, the marking portion 55 may be provided at a position of the sound guide portion 29 and/or the insertion member 40 that can directly or indirectly indicate the insertion position of the insertion member 40 (particularly, the insertion main body portion 41) in the insertion hole 36. In this case, the user can insert the insertion member 40 (particularly, the insertion main body portion 41) into the insertion hole 36 by a desired amount accurately by attaching the insertion member 40 to the sound guide portion 29 while checking the marking portion 55.

The specific form of the marking portion 55 is not limited. Typically, the marking portion 55 is provided in a color different from a color of a peripheral member, or the marking portion 55 is provided as a concave portion and/or a convex portion, so that the marking portion 55 is configured to be visually recognizable.

Note that FIGS. 12 and 13 illustrate a case where the marking portion 55 is provided on the sound guide portion 29 and the insertion member 40 illustrated in FIGS. 3 and 4 described above. However, the marking portion 55 can also be formed on the sound guide portion 29 and/or the insertion member 40 of another form (for example, see FIGS. 5 to 11 described above).

[Modifications]

In the above-described embodiments, the insertion member 40 is provided as the equalizer, but the insertion member 40 may not be the equalizer and may be provided as a structure capable of exhibiting other arbitrary functions. For example, like the wax guard described above, the insertion member 40 may be provided as a simple foreign substance entry prevention member.

Although the tabs 42 described above (see, for example, FIGS. 4, 6, 12, and 13) have a relatively wide film shape, the tabs 42 can have any shape, for example, may have a thread-like shape.

In the above-described embodiments, the sound guide portion 29 and the earpiece 30 are provided separately so as to be separable, but the sound guide portion 29 and the earpiece 30 may be provided as an integral structure that cannot be basically separated. The above-described “hole portion 35” may be provided in a portion of such an integrated structure that directly contacts the user's ear, and the above-described insertion member 40 can be inserted into the insertion hole 36 of the hole portion 35, or the above-described cutout portion 50 can be formed in the hole portion 35.

An installation position of the microphone 22 in the earphone 10 (earphone part) is not limited. The microphone 22 may be provided on the side opposite to the earpiece 30 via the speaker unit 28 (see FIG. 2 described above), or may be provided between the speaker unit 28 and the earpiece 30.

In addition, the earphone 10 (earphone part) includes one microphone 22 in the example illustrated in FIG. 2 described above, but may include two or more microphones and can include at least one microphone. As an example, the earphone 10 (earphone part) may include a first microphone provided between the speaker unit 28 and the earpiece 30, and a second microphone provided on a side opposite to the earpiece 30 via the speaker unit 28. In this case, the sound signal output from the first microphone may be used as the feedback noise-cancelling signal. On the other hand, a sound signal output from the second microphone (for example, the microphone 22 illustrated in FIG. 2) may be used for the feed-forward noise-cancelling signal.

It should be noted that the embodiments and modifications disclosed in the present description are illustrative only in all respects and are not to be construed as limiting. The above-described embodiments and modifications can be omitted, replaced, and changed in various forms without departing from the scope and spirit of the appended claims. For example, the above-described embodiments and modifications may be combined in whole or in part, and other embodiments may be combined with the above-described embodiments or modifications. Furthermore, the effects of the present disclosure described in the present description are merely exemplification, and other effects may be provided.

In addition, the technical category that embodies the technical idea described above is not limited, and for example, the technical idea described above may be embodied as a method such as a manufacturing method or a use method.

### Supplementary Note

The present disclosure can also have the following configurations.

### [Item 1]

An ear wearing sound output device including:
a speaker unit;
a sound guide portion that includes a hole portion having an insertion hole and transmits sound output from the speaker unit via the hole portion; and
an insertion member that includes an insertion main body portion located in the insertion hole, and a tab integrally provided with the insertion main body portion and at least partially located outside the insertion hole.

### [Item 2]

The ear wearing sound output device according to Item 1,
in which the tab includes
a tab coupling portion coupled to the insertion main body portion and extending in an extending direction of the insertion hole, and
a tab extension portion coupled to the tab coupling portion and separated from the insertion main body portion.

### [Item 3]

The ear wearing sound output device according to Item 1,
in which the tab includes
a tab coupling portion coupled to the insertion main body portion and extending in a circumferential direction of the insertion hole, and
a tab extension portion coupled to the tab coupling portion and separated from the insertion main body portion.

### [Item 4]

The ear wearing sound output device according to any one of Items 1 to 3,
in which the hole portion includes a cutout portion, and
at least a part of the tab is located in the cutout portion.

### [Item 5]

The ear wearing sound output device according to any one of Items 1 to 4,
in which at least a part of the tab is located at a position different from the insertion main body portion with respect to the extending direction of the insertion hole.

### [Item 6]

The ear wearing sound output device according to Item 5,
in which the tab has a hollow portion covering at least a part of the insertion hole.

### [Item 7]

The ear wearing sound output device according to any one of Items 1 to 6,
in which the tab includes a marking portion that is visually recognizable.

### [Item 8]

The ear wearing sound output device according to any one of Items 1 to 7,
in which the sound guide portion includes a marking portion that is visually recognizable.

### [Item 9]

The ear wearing sound output device according to any one of Items 1 to 8,
in which the tab has a film shape.

### [Item 10]

The ear wearing sound output device according to any one of Items 1 to 9,
in which at least a part of the tab includes a resin.

### [Item 11]

The ear wearing sound output device according to any one of Items 1 to 10,
in which at least a part of the tab is configured by a flexible member.

### [Item 12]

The ear wearing sound output device according to any one of Items 1 to 11,
in which rigidity of at least a part of the tab is higher than rigidity of the insertion main body portion.

### [Item 13]

The ear wearing sound output device according to any one of Items 1 to 12,
in which the insertion main body portion has a cushioning property.

### [Item 14]

The ear wearing sound output device according to any one of Items 1 to 13,
in which the insertion member is provided as an equalizer that adjusts a frequency of sound transmitted via the hole portion.

### [Item 15]

The ear wearing sound output device according to any one of Items 1 to 14,
in which the insertion member is provided as a foreign substance entry prevention body that suppresses entry of a foreign substance into the insertion hole.

### [Item 16]

The ear wearing sound output device according to any one of Items 1 to 15, further including
a microphone.

### [Item 17]

The ear wearing sound output device according to Item 16, further including
a signal processing portion that processes a sound signal output from the microphone,
in which the speaker unit outputs sound based on the sound signal processed by the signal processing portion.

### [Item 18]

The ear wearing sound output device according to any one of Items 1 to 17, further including
a detachable member provided separately from the insertion member and detachably attached to the sound guide portion.

### [Item 19]

The ear wearing sound output device according to Item 18,
in which the detachable member includes an ear attachment that emits sound transmitted from the sound guide portion.

### [Item 20]

The ear wearing sound output device according to Items 16 to 19, having
a hearing aid function of outputting surrounding sound collected by the microphone from the speaker unit.

### [Item 21]

An ear wearing sound output device including:
a speaker unit;
a sound guide portion that includes a hole portion having an insertion hole and a cutout portion and transmits sound output from the speaker unit via the hole portion; and
an insertion member including an insertion main body portion located in the insertion hole.

### [Item 22]

The ear wearing sound output device according to Item 21,
in which the insertion member includes a tab provided integrally with the insertion main body portion and at least partially located outside the insertion hole.

### [Item 23]

The ear wearing sound output device according to Item 22,
in which the tab includes
a tab coupling portion coupled to the insertion main body portion and extending in an extending direction of the insertion hole, and
a tab extension portion coupled to the tab coupling portion and separated from the insertion main body portion.

### [Item 24]

The ear wearing sound output device according to Item 22,
in which the tab includes
a tab coupling portion coupled to the insertion main body portion and extending in a circumferential direction of the insertion hole, and
a tab extension portion coupled to the tab coupling portion and separated from the insertion main body portion.

### [Item 25]

The ear wearing sound output device according to any one of Items 22 to 24,
in which the hole portion includes a cutout portion, and
at least a part of the tab is located in the cutout portion.

### [Item 26]

The ear wearing sound output device according to any one of Items 22 to 25,
in which at least a part of the tab is located at a position different from the insertion main body portion with respect to the extending direction of the insertion hole.

### [Item 27]

The ear wearing sound output device according to Item 26,
in which the tab has a hollow portion covering at least a part of the insertion hole.

### [Item 28]

The ear wearing sound output device according to any one of Items 22 to 27,
in which the tab includes a marking portion that is visually recognizable.

### [Item 29]

The ear wearing sound output device according to any one of Items 21 to 28,
in which the sound guide portion includes a marking portion that is visually recognizable.

### [Item 30]

The ear wearing sound output device according to any one of Items 22 to 29,
in which the tab has a film shape.

### [Item 31]

The ear wearing sound output device according to any one of Items 22 to 30,
in which at least a part of the tab includes a resin.

### [Item 32]

The ear wearing sound output device according to any one of Items 22 to 31,
in which at least a part of the tab is configured by a flexible member.

### [Item 33]

The ear wearing sound output device according to any one of Items 22 to 32,
in which rigidity of at least a part of the tab is higher than rigidity of the insertion main body portion.

### [Item 34]

The ear wearing sound output device according to any one of Items 21 to 33,
in which the insertion main body portion has a cushioning property.

### [Item 35]

The ear wearing sound output device according to any one of Items 21 to 34,
in which the insertion member is provided as an equalizer that adjusts a frequency of sound transmitted via the hole portion.

### [Item 36]

The ear wearing sound output device according to any one of Items 21 to 35,
in which the insertion member is provided as a foreign substance entry prevention body that suppresses entry of a foreign substance into the insertion hole.

### [Item 37]

The ear wearing sound output device according to any one of Items 21 to 36, further including
a microphone.

### [Item 38]

The ear wearing sound output device according to Item 37, further including
a signal processing portion that processes a sound signal output from the microphone,
in which the speaker unit outputs sound based on the sound signal processed by the signal processing portion.

### [Item 39]

The ear wearing sound output device according to any one of Items 21 to 38, further including
a detachable member provided separately from the insertion member and detachably attached to the sound guide portion.

### [Item 40]

The ear wearing sound output device according to Item 39,
in which the detachable member includes an ear attachment that emits sound transmitted from the sound guide portion.

### [Item 41]

The ear wearing sound output device according to any one of Items 37 to 40, having
a hearing aid function of outputting surrounding sound collected by the microphone from the speaker unit.

### [Item 42]

An insertion member attached to a hole portion of an ear wearing sound output device, the insertion member including:
an insertion main body portion; and
a tab provided integrally with the insertion main body portion and at least partially located outside the insertion hole in a state where the insertion main body portion is located in the insertion hole of the hole portion.

### [Item 43]

The insertion member according to Item 42,
in which the insertion member includes a tab provided integrally with the insertion main body portion and at least partially located outside the insertion hole.

### [Item 44]

The insertion member according to Item 43,
in which the tab includes
a tab coupling portion coupled to the insertion main body portion and extending in an extending direction of the insertion hole, and
a tab extension portion coupled to the tab coupling portion and separated from the insertion main body portion.

### [Item 45]

The insertion member according to Item 43,
in which the tab includes
a tab coupling portion coupled to the insertion main body portion and extending in a circumferential direction of the insertion hole, and
a tab extension portion coupled to the tab coupling portion and separated from the insertion main body portion.

### [Item 46]

The insertion member according to any one of Items 43 to 45,
in which the hole portion includes a cutout portion, and
at least a part of the tab is located in the cutout portion.

### [Item 47]

The insertion member according to any one of Items 43 to 46,
in which at least a part of the tab is located at a position different from the insertion main body portion with respect to the extending direction of the insertion hole.

### [Item 48]

The insertion member according to Item 47,
in which the tab has a hollow portion covering at least a part of the insertion hole.

### [Item 49]

The insertion member according to any one of Items 43 to 48,
in which the tab includes a marking portion that is visually recognizable.

### [Item 50]

The insertion member according to any one of items 42 to 49,
in which a sound guide portion that includes the hole portion having the insertion hole and transmits sound output from a speaker unit via the hole portion includes a visually recognizable marking portion.

### [Item 51]

The insertion member according to any one of Items 43 to 50,
in which the tab has a film shape.

### [Item 52]

The insertion member according to any one of Items 43 to 51,
in which at least a part of the tab includes a resin.

### [Item 53]

The insertion member according to any one of Items 43 to 52,
in which at least a part of the tab is configured by a flexible member.

### [Item 54]

The insertion member according to any one of Items 43 to 53,
in which rigidity of at least a part of the tab is higher than rigidity of the insertion main body portion.

### [Item 55]

The insertion member according to any one of Items 42 to 54,
in which the insertion main body portion has a cushioning property.

### [Item 56]

The insertion member according to any one of Items 42 to 55,
in which the insertion member is provided as an equalizer that adjusts a frequency of sound transmitted via the hole portion.

### [Item 57]

The insertion member according to any one of Items 42 to 56,
in which the insertion member is provided as a foreign substance entry prevention body that suppresses entry of a foreign substance into the insertion hole.

### [Item 58]

The insertion member according to any one of Items 42 to 57, further including
a microphone.

### [Item 59]

The insertion member according to Item 58, further including
a signal processing portion that processes a sound signal output from the microphone,
in which the speaker unit outputs sound based on the sound signal processed by the signal processing portion.

### [Item 60]

The insertion member according to any one of Items 42 to 59, further including
a detachable member provided separately from the insertion member and detachably attached to the sound guide portion.

### [Item 61]

The insertion member according to Item 60,
in which the detachable member includes an ear attachment that emits sound transmitted from the sound guide portion.

### [Item 62]

The insertion member according to any one of Items 58 to 61, having
a hearing aid function of outputting surrounding sound collected by the microphone from the speaker unit.

### REFERENCE SIGNS LIST

10 Earphone
11 Charger case
12 Electronic apparatus
21 Top case
22 Microphone
23 Antenna
24 Earphone battery
25 Control circuit
26 Bottom case
27 Supporter
28 Speaker unit
29 Sound guide portion
30 Earpiece
31 Output through hole
35 Hole portion
36 Insertion hole
40 Insertion member
41 Insertion main body portion
42 Tab
42a Tab coupling portion
42b Tab extension portion
42c Hollow portion
42d Outer peripheral surrounding portion
42e Outer peripheral extension portion
50 Cutout portion
55 Marking portion

1. An ear wearing sound output device comprising:
a speaker unit;
a sound guide portion that includes a hole portion having an insertion hole and transmits sound output from the speaker unit via the hole portion; and
an insertion member that includes an insertion main body portion located in the insertion hole, and a tab integrally provided with the insertion main body portion and at least partially located outside the insertion hole.

2. The ear wearing sound output device according to claim 1,
wherein the tab includes
a tab coupling portion coupled to the insertion main body portion and extending in an extending direction of the insertion hole, and
a tab extension portion coupled to the tab coupling portion and separated from the insertion main body portion.

3. The ear wearing sound output device according to claim 1,
wherein the tab includes
a tab coupling portion coupled to the insertion main body portion and extending in a circumferential direction of the insertion hole, and
a tab extension portion coupled to the tab coupling portion and separated from the insertion main body portion.

4. The ear wearing sound output device according to claim 1,
wherein the hole portion includes a cutout portion, and
at least a part of the tab is located in the cutout portion.

5. The ear wearing sound output device according to claim 1,
wherein at least a part of the tab is located at a position different from the insertion main body portion with respect to the extending direction of the insertion hole.

6. The ear wearing sound output device according to claim 5,
wherein the tab has a hollow portion covering at least a part of the insertion hole.

7. The ear wearing sound output device according to claim 1,
wherein the tab includes a marking portion that is visually recognizable.

8. The ear wearing sound output device according to claim 1,
wherein the sound guide portion includes a marking portion that is visually recognizable.

9. The ear wearing sound output device according to claim 1,
wherein at least a part of the tab includes a resin.

10. The ear wearing sound output device according to claim 1,
wherein rigidity of at least a part of the tab is higher than rigidity of the insertion main body portion.

11. The ear wearing sound output device according to claim 1,
wherein the insertion main body portion has a cushioning property.

12. The ear wearing sound output device according to claim 1,
wherein the insertion member is provided as an equalizer that adjusts a frequency of sound transmitted via the hole portion.

13. The ear wearing sound output device according to claim 1,
wherein the insertion member is provided as a foreign substance entry prevention body that suppresses entry of a foreign substance into the insertion hole.

14. The ear wearing sound output device according claim 1, further comprising
a microphone.

15. The ear wearing sound output device according to claim 14, further comprising
a signal processing portion that processes a sound signal output from the microphone,
wherein the speaker unit outputs sound based on the sound signal processed by the signal processing portion.

16. The ear wearing sound output device according to claim 1, further comprising
a detachable member provided separately from the insertion member and detachably attached to the sound guide portion.

17. The ear wearing sound output device according to claim 16,
wherein the detachable member includes an ear attachment that emits sound transmitted from the sound guide portion.

18. The ear wearing sound output device according to claim 14, having a hearing aid function of outputting surrounding sound collected by the microphone from the speaker unit.

19. An ear wearing sound output device comprising:
a speaker unit;
a sound guide portion that includes a hole portion having an insertion hole and a cutout portion and transmits sound output from the speaker unit via the hole portion; and
an insertion member including an insertion main body portion located in the insertion hole.

20. An insertion member attached to a hole portion of an ear wearing sound output device, the insertion member comprising:
an insertion main body portion; and
a tab provided integrally with the insertion main body portion and at least partially located outside the insertion hole in a state where the insertion main body portion is located in the insertion hole of the hole portion.
